(19) United States
(12) Patent Application Publication
(10) Pub. No.: US 2018/0039919 A1
(43) Pub. Date: Feb. 8, 2018

(54) AUTONOMOUS COMPUTERIZED SYSTEM FOR MANAGING EXERCISABLE RIGHTS

(71) Applicant: Stephen L Tucker, Aurora, CO (US)

(72) Inventor: Stephen L Tucker, Aurora, CO (US)

(21) Appl. No.: 15/783,374

(22) Filed: Oct. 13, 2017

Related U.S. Application Data
(63) Continuation of application No. 13/176,211, filed on Jul. 5, 2011.

(51) Int. Cl. G06Q 10/02; G06Q 50/14

(52) U.S. Cl. CPC G06Q 10/02; G06Q 50/14

(57) ABSTRACT

A method and apparatus for selecting travel related services. The method includes the step of determining a plurality of travel related services that a consumer of such services can select for their own use. Each service has a start and end date. The services are stored in a database from which they are published to consumers. Consumers may then select the services of interest to them. Should a consumer not be able to use the selected service within its start and end date, the consumer may make the service available to other consumers for selection. An associated apparatus is provided to implement the process.

### CROSS-REFERENCE TO RELATED APPLICATION

This is a continuation application and claims priority to application Ser. No. 13/176,211 entitled “Method And Apparatus For Selecting Travel And Entertainment Related Goods And Services”.

### TECHNICAL FIELD

The present invention is generally directed to the field of travel and travel related services and more particularly, is directed to an autonomous computerized system for managing exercisable rights related to such travel and related services.

### BACKGROUND OF THE TECHNOLOGY

The financial crisis of 2008 has created the need for a new way of marketing travel and entertainment products. People don't have the same level of discretionary income that they had before the financial crash. The present invention provides a new concept for travel and resort-style living. This concept does not require full ownership but carries many similar benefits. The present invention represents the first substantial innovation in marketing travel and entertainment related services since the creation of time-share and fractional ownership many years ago.

Existing travel marketing methods are not affordable or sustainable in today's economy. Time-share cost includes an upfront fee of an average $5,000 to $25,000 for a week, yearly assessments, and then minimum costs for the stay. Fractional sales include an initial purchase ranging from $100,000 to $500,000 for 1½ to 3 months, with expensive annual assessments and minimal per stay costs. Whole ownership is very expensive and dictates where a person will spend most of his or her vacation or retirement time. It includes the cost of initial purchase, management, security, taxes, insurance and yearly or monthly home owner's fees and assessments.

There is very little real equity opportunity in current destination ownership models. Customers have been sold property ownership partially on the notion of long term equity and value. In the current economic conditions, there is very little equity in time-shares, fractional, and even in full ownership in many cases.

Thus, there is a need in the art for an improved method and apparatus for planning and sharing travel and travel related services which overcome the above noted problems and deficiencies related to current approaches used to acquire such services.

The novel features of the present invention are set out with particularity in the following detailed description of the preferred embodiment. However, the invention will be understood more fully and clearly from the detailed description of the invention as set forth in the accompanying drawings in which:

### BRIEF DESCRIPTION OF THE DRAWINGS

FIG. 1 is a block diagram of the system architecture of one embodiment of an apparatus which implements the method of the present invention;

FIG. 2 is a block diagram of a clearing house software application in accordance with one embodiment of the present invention;

FIG. 3 is a block diagram of an option store software application in accordance with one embodiment of the present invention;

FIG. 4 is a block diagram of a membership software application in accordance with one embodiment of the present invention;

FIG. 5 is a block diagram of the lifecycle of a travel option in accordance with one embodiment of the present invention;

FIG. 6 is a block diagram of the lifecycle of an event option in accordance with one embodiment of the present invention;

FIG. 7 is a flow diagram of one embodiment of the present inventions; and

FIG. 8 is a block diagram of an autonomous computer control system in accordance with the represent invention.

### DETAILED DESCRIPTION OF THE PREFERRED EMBODIMENT

The present invention will now be described with reference to the accompanying drawings.

As used in the present invention, the term “Option” refers to a privilege acquired, as by the payment of a premium or consideration, within a specified time, the carrying out of a transaction upon stipulated terms; the right, as granted in a contract or by an initial payment, to acquire something in the future. For example: “We bought one lot and took a 90-day option on an adjoining one.”

The term “Destination Option” refers to an option for a fixed length stay occurring at a yearly frequency. The options must be exercised 6-9 months before travel will occur.

The term “Entertainment Option” refers to an option for a particular season of sports, theater, music, or other type of entertainment. This option secures the right to purchase season tickets at a discounted rate for a specific seat, standing room only or other space.

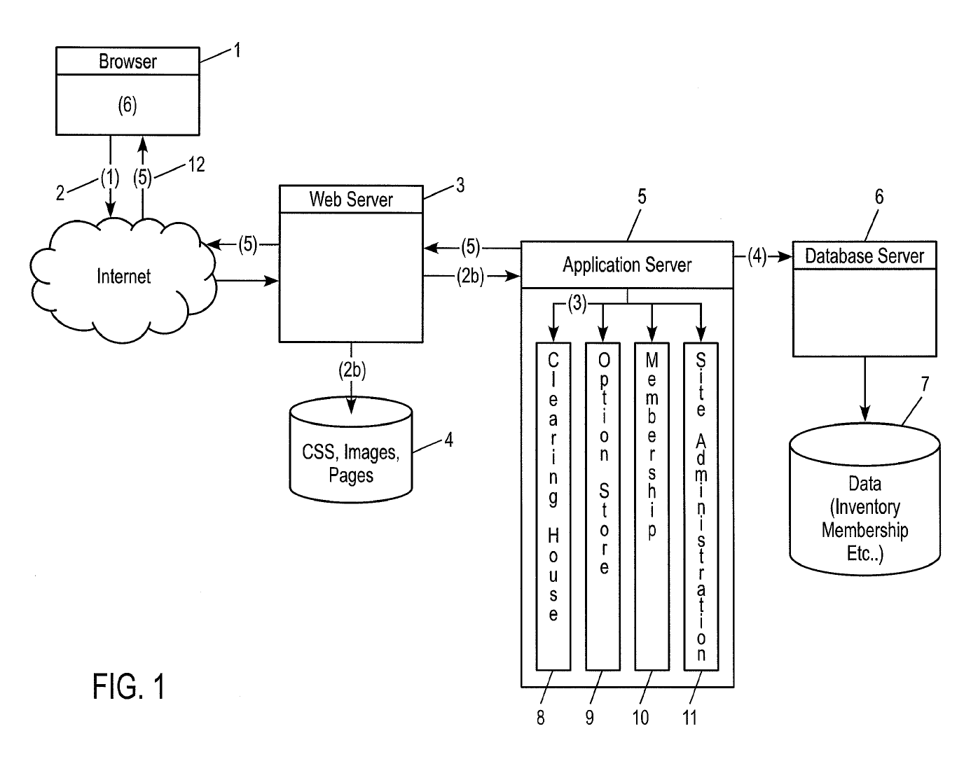

FIG. 1 is a block diagram of the system architecture of one embodiment of an apparatus which implements the method of the present invention. As illustrated in FIG. 1, a user using web browser 1 sends a request 2 for a page or resource from a website located on web server 3. As is known in the art, the request is propagated over the Internet to web server 3.

Web server 3 determines how to process the request. Static resources such as images, CSS and static web pages are read from a storage device 4 connected to web server 3, as one of ordinary skill in the art would understand, and returned to web browser 1 via the Internet.

Requests for dynamic resources are forwarded to application server 5. Application server 5 passes the request to the correct web application (Clearing House Application 8, Option Store Application 9, Membership Application 10, Site Administrator Application 11) as dictated by the user request. The appropriate web application constructs a response 12 to the user request 2 using data from database server 6 when necessary. Database server 6 has access to a number of data tables 7 which provide needed information for the web application to construct the response 12.

Response 12 is passed back to the user's browser 1 via application server 5, webs server 3 and the Internet. Browser 1 then displays response 12 to the user.

As known in the art, web server 3, application server 5 and database server 6 are independent pieces of software which can be installed on the same computer or different computers. This provides systems administrators the flexibility required to scale the system architecture as usage grows.

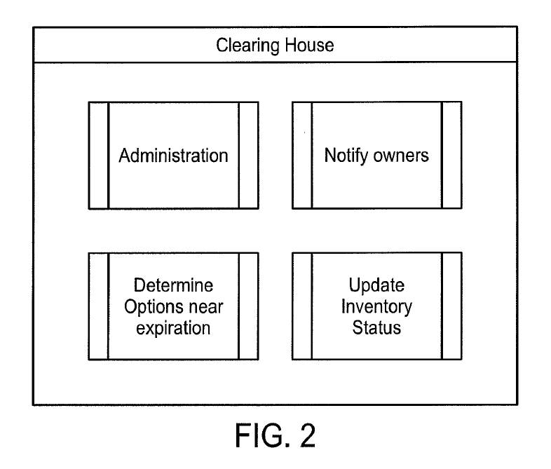

FIG. 2 is a block diagram of Clearing House Application 8. Clearing

House Application 8 supports the following core functionalities:
(1) Determining Options that are near expiration and notifying owners;
(2) Allowing owners to offer owned options in the clearing house by updating the inventory status internally;
(3) Allowing users to share owned current or future year options with other users;
(4) Providing Clearing House administration capabilities; and
(5) Utilizing the Option store to offer timeslot inventory.

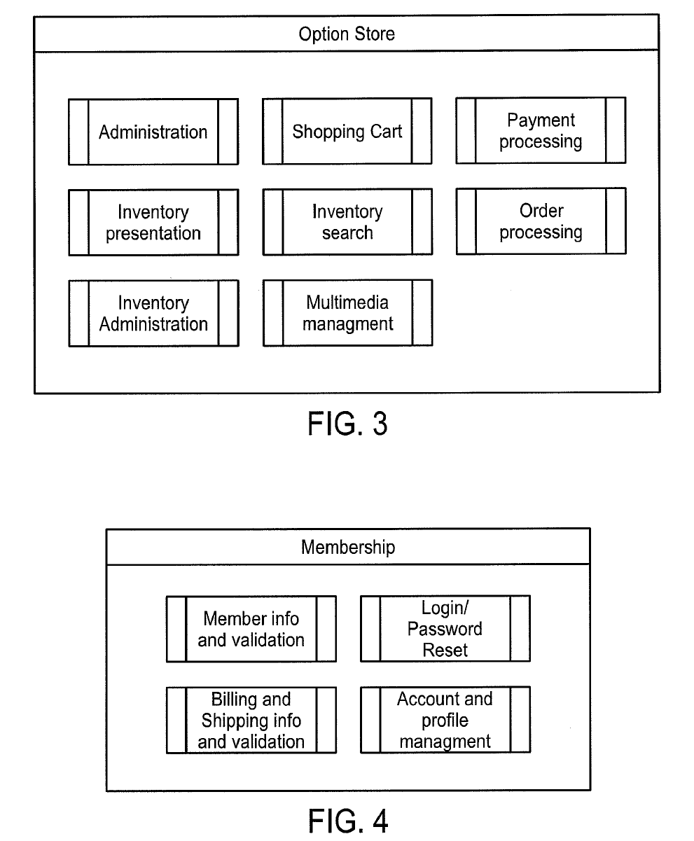

FIG. 3 is a block diagram of Option Store Application 9. Option Store Application 9 is utilized for the e-commerce functionality of the website. It is capable of typical store functionality including:
(1) Payment and Billing information gathering and storage;
(2) Shopping cart functionality;
(3) Inventory presentation;
(4) Inventory Search;
(5) Inventory Administration;
(6) Multimedia management;
(7) Store Administration; and
(8) Order processing.

FIG. 4 is a block diagram of Membership Application 10. Membership Application 10 provides the following functionality:
(1) Member information and validation;
(2) Login/Password Reset;
(3) Account and profile management; and
(4) Billing and Shipping information validation.

Site Administration Application 11 provides administrators of the system the ability to change site-wide settings and access the content management system to update page content, store settings, and other settings.

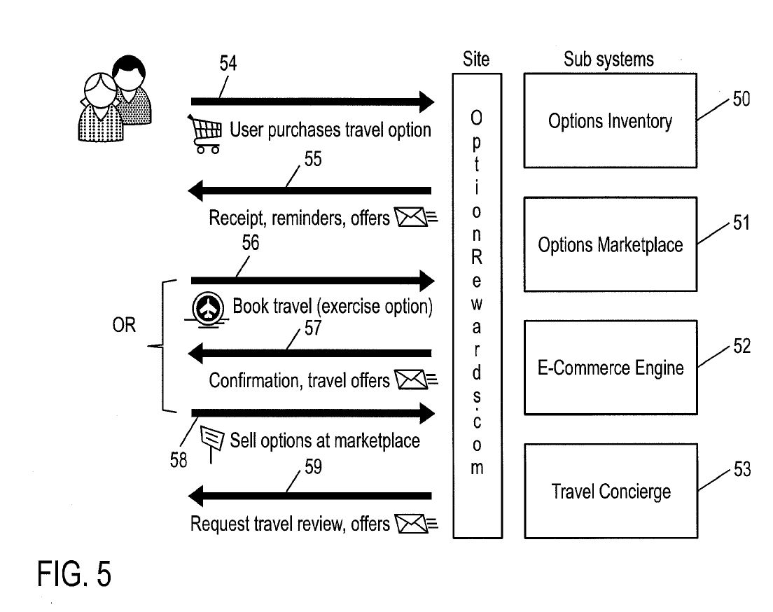

FIG. 5 is a block diagram of the lifecycle of a travel option. As shown in FIG. 5, Options Inventory 50 stores all of the available options. Options Marketplace 51 represents the options marketplace. In accordance with the present invention, a travel option can be for 1 or more accommodations for a stay of a minimum number of days to a maximum number of days. In one embodiment of the present inventions, a travel option can be exercised once per year for between 1-20 years depending on the purchase. Travel options are priced based on class and number of years.

E-Commerce Engine 52 is setup to receive payments from those wishing to purchase travel options as those of ordinary skill in the art would understand.

Travel Concierge 53 is a referral system that links to other providers of related travel and leisure services.

Arrows 54-59 shown in FIG. 5 illustrate the interchange between a user and the system of the invention.

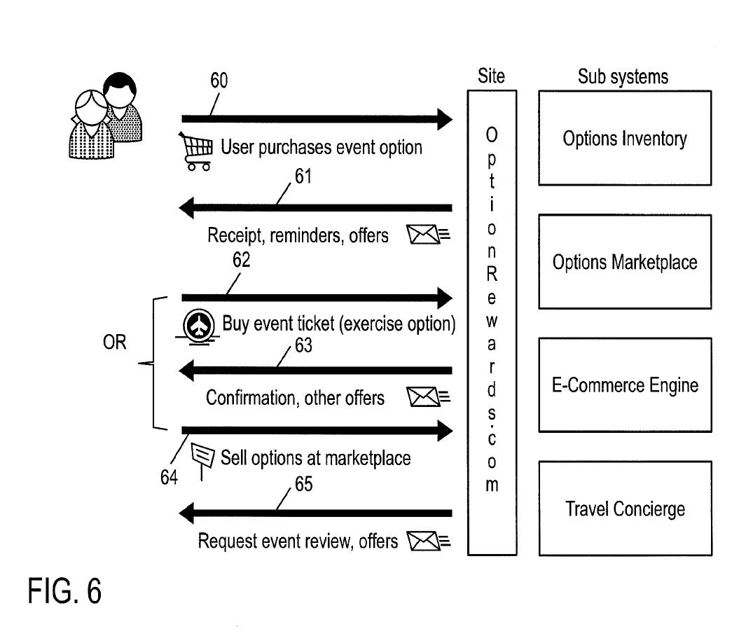

FIG. 6 is a block diagram of the lifecycle of an event option in accordance with the present invention. An event option is for one event or one series of events (e.g. season tickets to theater). Arrows 60-65 shown in FIG. 6 illustrate the interchange between a user and the system of the invention with respect to an event option.

The system and method of the present invention provides a new level of travel planning and flexibility to the consumer. It allows people to not be tied down to one location. The system and method also allows for a much lower investment in purchasing travel options. The investment is much lower than the investment need for full or fractional ownership of a property or the cost of a time-share or destination resort club.

Vacationers, retirees, or persons looking for a second home fit perfectly into the system and method of the present invention. For a minimal cost, a person can hold several options in different locations and pay no up-front purchase price, no maintenance, or yearly assessment fees, no mortgage, but receive a discounted rental fee.

Unlike competing travel marketing methods, purchasing options is very low risk. One does not have a large purchase price, regular maintenance fees and dues, etc. In addition, if one is unable to exercise the option purchased he or she will have the ability to make that option available to others in the marketplace in order to minimize the loss of the investment.

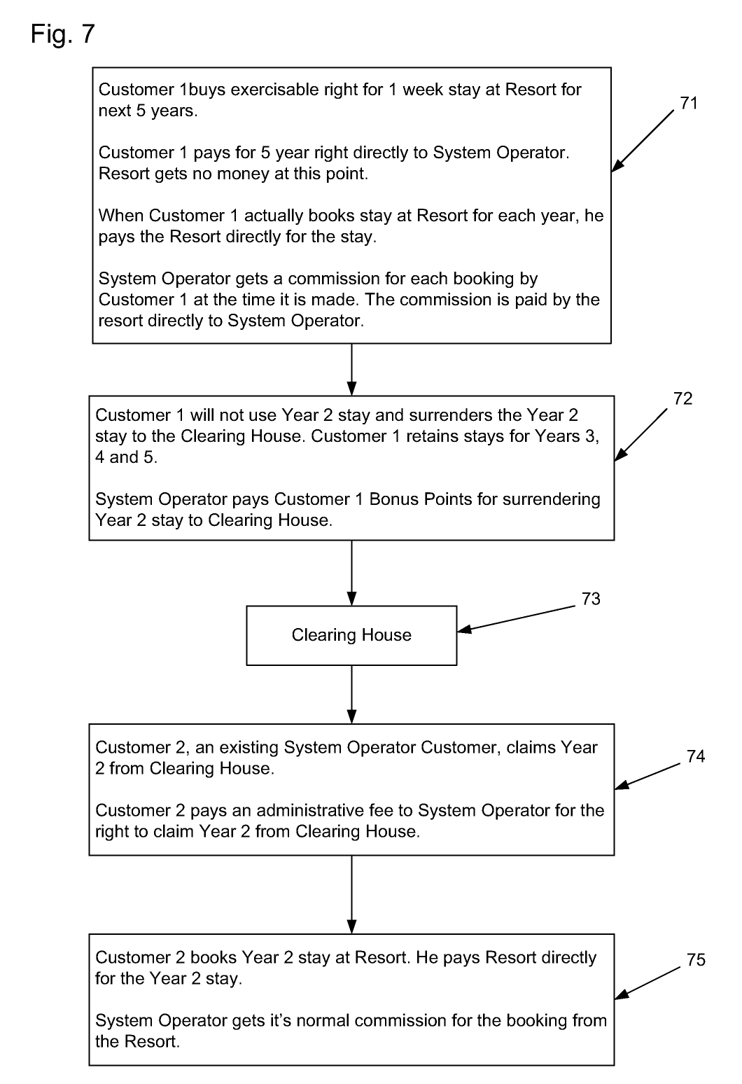

FIG. 7 is a flow diagram of one embodiment of the operation of an autonomous computerized system for managing exercisable rights in accordance with the present invention.

The exercisable right described in FIG. 7 is the right that a customer has purchased from the operator of the present invention, i.e., the “System Operator”, to stay at a third party Resort for five consecutive years. In accordance with the present invention, this right can be segmented into five sub rights, one sub right for each year of occupancy at the resort.

As shown in FIG. 7, Customer 1 buys from the System Operator the exercisable right to stay at the resort for one week for each of five consecutive years.

As illustrated in Block 71 of FIG. 7, Customer 1 pays for the five-year right directly to the System Operator. The Resort receives no payment until Customer 1 actually books the one-week stay at the Resort. The reference to a “one-week stay” is merely by way of example. The period of time may be of any duration.

At the time of booking, Customer 1 pays directly to the Resort a previously agreed upon rate for the one-week booking. At the same time, Customer 1 pays to the System Operator a commission for the one-week booking.

Block 72 illustrates the a decision made by Customer 1 to forego booking the one-week stay in Year 2 for which he has the right to do. It may be that Customer 1's plans have change for Year 2 and he will not be able to exercise his sub-right for the Year 2 booking.

In that case, Customer 1 surrenders his sub-right for Year 2 to the System Operators' Clearing House as shown in Block 73 of FIG. 7. However, Customer 1 retains his sub-rights for Years 3, 4 and 5. If Customer 1 has not yet exercised his sub-right for Year 1, he retains that sub-right as well.

The Clearing house serves as a central repository of sub-rights that have been relinquished by customers for various reasons of the customer's choosing. Other customers may then claim these sub-rights for themselves and complete the booking for the resort in their name in the same manner as the original owner of the sub-right would have been able to too.

Thus, as shown in Block 74, Customer 2 claims Customer 1's relinquished sub-right for his own use. Customer 2 may be required to pay an administrative fee to the System Operator for the privilege of claiming the sub-right out of the Clearing House.

Block 75 of FIG. 7 illustrates Customer 2 booking the Year 2 stay at the Resort in the same manner as Customer 1 would have booked the stay had his sub-right not been relinquished to the Clearing House.

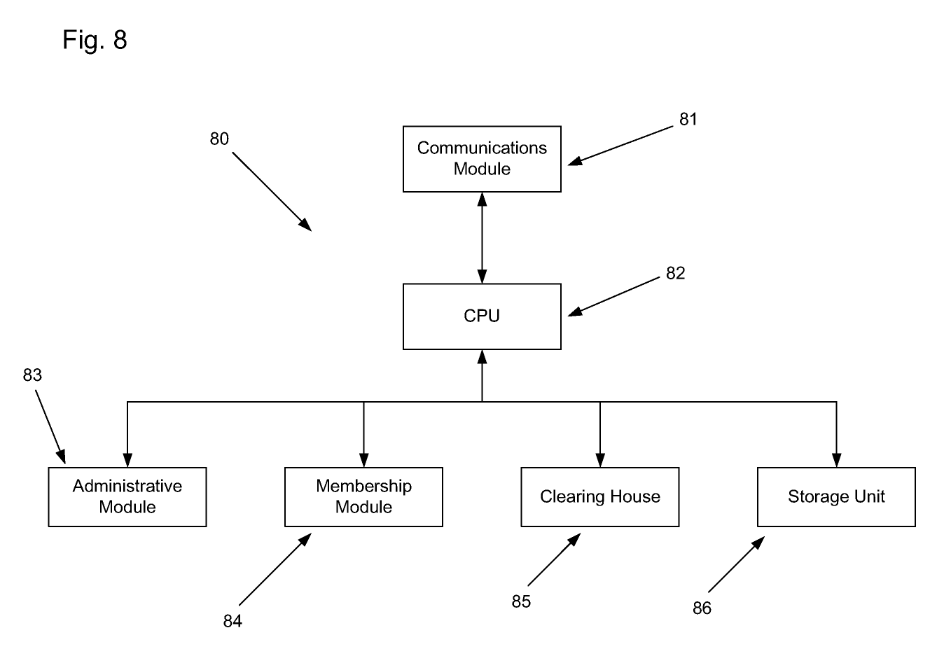

The process described in FIG. 7 operates autonomous under the control of a computer system, for example, computer system 80 as illustrated in FIG. 8.

Computer system 80 includes Communications Module 81 through which participants in the system, such the System Operator, Customers and vendors, communicate with the system.

Communications Module 81 is coupled to CPU 82 which controls the operation of the system. CPU 82 is coupled to a number of operating modules, such as Administration Module 83, Customer Module 84, Clearing House 85 and Storage Unit 86.

Administration Module 83 is used to administer the operation of Clearing House 85. Customer Module 84 is used to manage the various customers, or members, of the system. Storage Unit 86 serves as a central database for the system.

While the foregoing specification teaches the principles of the present invention, with examples provided for the purpose of illustration, it will be appreciated by one skilled in the art from reading this disclosure that various changes in form and detail can be made without departing from the true scope of the invention.

I claim:

1. An autonomous electronic computer system for managing the ownership of exercisable rights among members of said system in accordance with a set of predetermined exercise rules, said exercisable rights being provided by exercisable rights providers for ownership by members of said system, each of said exercisable rights being comprised of a plurality of separately exercisable sub-rights, said computer system comprising:
a central processing unit (CPU) for controlling the operation of said electronic computer system;
a storage unit coupled to said CPU for storing said exercisable rights that are owned by members of said system; and
a clearing house coupled to said CPU for storing said exercisable sub-rights that have been relinquished by their owners, said clearing house comprising:
an administration module for administrating said clearing house;
a membership module coupled to said administration module for managing the members of said system; and
a communications module coupled to said administration module for communication the availability and status of said sub-exercisable rights to said members.

2. The system of claim 1, wherein said CPU resides in a webserver accessible on the Internet.

3. The system of claim 2, further including a webserver for delivering web pages to the members of said system.

4. The system of claim 4, wherein said webserver includes an application server.

5. The system of claim 1, wherein said communications module is coupled to the Internet.

6. A method of selecting options that can be exercised for travel related services, said method comprising the steps of:
establishing, by a computer system, a plurality of subscribers to said method to whom options to be exercised can be presented;
establishing, by a computer system, a plurality of said options having a start date and an end date;
storing said options in a database;
publishing from said database the availability of said options to said plurality of subscribers based on said start date and said end date;
determining, by a computer system, said options that are nearing said end date;
notifying, by a computer system, said plurality of subscribers of said options that are nearing said end date;
in response to said notifying step, receiving, by a computer system, from responding ones of said subscribers selections of options to be exercised by respective ones of said responding subscribers for their own use; and
transferring, by a computer system, said options selected to be exercised by said responding subscribers to the respective subscribers for exercising by the respective subscribers; and
facilitating, by a computer system, transfer of the right to exercise said selected option from one said subscriber to a second said subscriber without remuneration.

7. The method of claim 6 further including the step of:
facilitating , by a computer system, the transfer of the right to exercise said selected option from one said subscriber to a second said subscriber without remuneration said travel related services between said consumers.
